(19) United States
(12) Patent Application Publication
(10) Pub. No.: US 2013/0301605 A1
(43) Pub. Date: Nov. 14, 2013

(54) METHOD, APPARATUS, AND COMPUTER PROGRAM PRODUCT FOR RESOURCE ALLOCATION FOR SEQUENTIAL/PARALLEL WIRELESS MESSAGES

(71) Applicants: Taejoon KIM, Berkeley, CA (US); Sayantan CHOUDHURY, Berkeley, CA (US); Klaus Franz DOPPLER, Albany, CA (US); Chittabrata GHOSH, Union City, CA (US); Esa TUOMAALA, Helsinki (FI); Zhong-Yi JIN, Albany, CA (US)

(72) Inventors: Taejoon KIM, Berkeley, CA (US); Sayantan CHOUDHURY, Berkeley, CA (US); Klaus Franz DOPPLER, Albany, CA (US); Chittabrata GHOSH, Union City, CA (US); Esa TUOMAALA, Helsinki (FI); Zhong-Yi JIN, Albany, CA (US)

(73) Assignee: Nokia Corporation, Espoo (FI)

(21) Appl. No.: 13/468,235

(22) Filed: May 10, 2012

(51) Int. Cl. H04W 72/04

(52) U.S. Cl. 370/330

(57) ABSTRACT

Method, apparatus, and computer program product embodiments provide signaling mechanisms for wireless networks composed of a large number of stations. An example method embodiment comprises: receiving by a wireless client device, a first message from an access point device, the first message comprising information related to resource allocation that at least partly indicates a resource allocation in time-frequency space for the wireless client device; decoding by the wireless client device, the information related to resource allocation, using a connection identifier that identifies the wireless client device within a wireless network managed by the access point device, to obtain the resource allocation in time-frequency space; and transmitting by the wireless client device to the access point device, a second message using the resource allocation in time-frequency space.

### FIELD

The field of technology relates to wireless communication and more particularly to signaling mechanisms for wireless networks composed of a large number of stations.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for signaling mechanisms for wireless networks composed of a large number of stations.

An example embodiment of the invention includes a method comprising:

receiving by a wireless client device, a first message from an access point device, the first message comprising information related to resource allocation that at least partly indicates a resource allocation in time-frequency space for the wireless client device;

decoding by the wireless client device, the information related to resource allocation, using a connection identifier that identifies the wireless client device within a wireless network managed by the access point device, to obtain the resource allocation in time-frequency space; and

transmitting by the wireless client device to the access point device, a second message using the resource allocation in time-frequency space.

An example embodiment of the invention includes a method comprising:

receiving by the wireless client device, another message from the access point device, the another message comprising information that can be used in addition to the information related to resource allocation, to determine at least one of a time slot and a frequency sub-band for transmitting the second message to the access point device.

An example embodiment of the invention includes a method comprising:

wherein the first message includes information related to an allocation of at least one of a time slot for transmission of the second message and a sub-band for transmission of the second message.

An example embodiment of the invention includes a method comprising:

wherein the wireless client device decodes the information related to resource allocation using an association identification of the wireless client device to derive an allocation of resources for the second message, comprising at least one of when the wireless client device should transmit the second message and which sub-band to use to transmit the second message.

An example embodiment of the invention includes a method comprising:

wherein the second message allocation is specified by at least one of a time slot index, a sub-band index, and a multiplexing index expressed by bit positions in lowest significant bits of the association identification of the wireless client device and the lowest significant bits can be dynamically changed to enable time slot and frequency sub-band shuffling, to provide frequency and time diversity for response message transmission.

An example embodiment of the invention includes a method comprising:

generating in an access point device, a first message comprising information related to resource allocation that indicates a resource allocation in time-frequency space for a wireless client device when decoded using a connection identifier that identifies the wireless client device within a wireless network managed by the access point device; and

transmitting the first message to the wireless client device.

An example embodiment of the invention includes a method comprising:

transmitting by the access point device to the wireless client device, another message comprising information that can be used in addition to the information related to resource allocation, to determine at least one of a time slot and a frequency sub-band for the wireless client device to transmit a second message.

An example embodiment of the invention includes a method comprising:

wherein the first message includes information related to at least one of a time slot for transmission of a second message and a sub-band for transmission for the wireless client device to transmit the second message.

An example embodiment of the invention includes a method comprising:

wherein an allocation of resources for the wireless client device, is based on the information related to resource allocation and an association identification of the wireless client device, the allocation of resources for the wireless client device, comprising at least one of when the wireless client device should transmit a second message and which sub-band to use to transmit the second message.

An example embodiment of the invention includes a method comprising:

wherein the second message allocation is specified by at least one of a time slot index, a sub-band index, and a multiplexing index expressed by bit positions in lowest significant bits of the association identification of the wireless client device and the lowest significant bits can be dynamically changed to enable time slot and frequency sub-band shuffling, to provide frequency and time diversity for response message transmission.

An example embodiment of the invention includes an apparatus comprising:

at least one processor;

at least one memory including computer program code;

the at least one memory and the computer program code configured to, with the at least one processor, cause the apparatus at least to:

receive a first message from an access point device, the first message comprising information related to resource allocation that at least partly indicates a resource allocation in time-frequency space for the apparatus;

decode the information related to resource allocation, using a connection identifier that identifies the apparatus within a wireless network managed by the access point device, to obtain the resource allocation in time-frequency space; and

transmit to the access point device, a second message using the resource allocation in time-frequency space.

An example embodiment of the invention includes an apparatus comprising:

the at least one memory and the computer program code configured to, with the at least one processor, cause the apparatus at least to:

receive another message from the access point device, the another message comprising information that can be used in addition to the information related to resource allocation, to determine at least one of a time slot and a frequency sub-band for transmitting the second message to the access point device.

An example embodiment of the invention includes an apparatus comprising:

wherein the first message includes information related to an allocation of at least one of a time slot for transmission of the second message and a sub-band for transmission of the second message.

An example embodiment of the invention includes an apparatus comprising:

wherein the apparatus decodes the information related to resource allocation using an association identification of the apparatus to derive an allocation of resources for the second message, comprising at least one of when the apparatus should transmit the second message and which sub-band to use to transmit the second message.

An example embodiment of the invention includes an apparatus comprising:

at least one processor;

at least one memory including computer program code;

the at least one memory and the computer program code configured to, with the at least one processor, cause the apparatus at least to:

generate a first message comprising information related to resource allocation that indicates a resource allocation in time-frequency space for a wireless client device when decoded using a connection identifier that identifies the wireless client device within a wireless network managed by the apparatus; and

transmit the first message to the wireless client device.

An example embodiment of the invention includes an apparatus comprising:

the at least one memory and the computer program code configured to, with the at least one processor, cause the apparatus at least to:

transmit to the wireless client device, another message comprising information that can be used in addition to the information related to resource allocation, to determine at least one of a time slot and a frequency sub-band for the wireless client device to transmit a second message.

An example embodiment of the invention includes an apparatus comprising:

wherein the first message includes information related to an allocation of at least one of a time slot for transmission of a second message and a sub-band for transmission for the wireless client device to transmit the second message.

An example embodiment of the invention includes an apparatus comprising:

wherein an allocation of resources for the wireless client device, is based on the information related to resource allocation and an association identification of the wireless client device, the allocation of resources for the wireless client device, comprising at least one of when the wireless client device should transmit a second message and which sub-band to use to transmit the second message.

An example embodiment of the invention includes a computer program product comprising computer executable program code recorded on a computer readable, non-transitory storage medium, the computer executable program code comprising:

code for receiving by a wireless client device, a first message from an access point device, the first message comprising information related to resource allocation that at least partly indicates a resource allocation in time-frequency space for the wireless client device;

code for decoding by the wireless client device, the information related to resource allocation, using a connection identifier that identifies the wireless client device within a wireless network managed by the access point device, to obtain the resource allocation in time-frequency space; and

code for transmitting by the wireless client device to the access point device, a second message using the resource allocation in time-frequency space.

An example embodiment of the invention includes a computer program product comprising computer executable program code recorded on a computer readable, non-transitory storage medium, the computer executable program code comprising:

code for generating in an access point device, a first message comprising information related to resource allocation that indicates a resource allocation in time-frequency space for a wireless client device when decoded using a connection identifier that identifies the wireless client device within a wireless network managed by the access point device; and

code for transmitting the first message to the wireless client device.

The resulting embodiments provide signaling mechanisms for wireless networks composed of a large number of stations.

### DESCRIPTION OF THE FIGURES

FIG. 1 shows the example network diagram, wherein a wireless access point device transmits to a group of wireless client devices in a wireless network that it manages, a polling message comprising information related to resource allocation that at least partly indicates a resource allocation in time-frequency space for the wireless client devices in the group, according to an example embodiment of the invention

FIG. 1A shows an example frame structure of the polling message that includes at least one information element to signal the group of wireless client devices, a resource allocation for at least one of a sequence of time slots and a range of frequency sub-bands for transmitting response messages by the members of the group, the figure further illustrating allocation decode logic in a wireless client device member of the group, to use its association identification (AID) to decode the at least one information element to derive a resource allocation for the member, according to an example embodiment of the invention.

FIG. 1B shows the example network diagram of FIG. 1, wherein wireless client devices in the group receive the polling message, decode it, and transmit response messages in at least one of a sequence of time slots and a range of frequency sub-bands, using the received resource allocation in time-frequency space, according to an example embodiment of the invention.

FIG. 1C shows examples of the response messages or ACKs transmitted by the group of wireless client devices in at least one of a sequence of time slots and a range of frequency sub-bands, in response to the polling message, according to an example embodiment of the invention.

FIG. 1D shows an example functional block diagram of the access point device, illustrating allocation encode logic in the access point device, to encode the at least one information element for appending to the polling message to transmit information related to resource allocation to a group of wireless client devices, according to an example embodiment of the invention, according to an example embodiment of the invention.

FIG. 2 illustrates an example distribution of response messages or ACKs over allocated frequency sub-bands when the value of the parameters Sequential/Parallel ACK=0 and Short/Long sequence=0, in accordance with an example embodiment of the invention.

FIG. 3 illustrates an example distribution of response messages or ACKs over allocated frequency sub-bands when the value of the parameters Sequential/Parallel ACK=1 and Short/Long sequence=0, in accordance with an example embodiment of the invention.

FIG. 4A is an example functional block diagram, illustrating an example wireless client device, according to an example embodiment of the invention.

FIG. 4B is an example flow diagram of operational steps in the wireless client device of FIG. 4A, according to an example embodiment of the invention.

FIG. 5A is an example functional block diagram, illustrating an example wireless access point device, according to an example embodiment of the invention.

FIG. 5B is an example flow diagram of operational steps in the wireless access point device of FIG. 5A, according to an example embodiment of the invention.

FIG. 6 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

### DISCUSSION OF EXAMPLE EMBODIMENTS OF THE INVENTION

This section is organized into the following topics:

A. WLAN Communication Technology

B. Resource Allocation For Sequential/Parallel Wireless Messages

C. Detailed Description of the Time Slot And Sub-Band Allocation

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j protocols, into the base standard IEEE 802.11-2007, Wireless Medium Access Control (MAC) and Physical Layer (PHY) Specifications, June 2007 (incorporated herein by reference). Since then, emerging broadband applications have stimulated interest in developing very high-speed wireless networks for short range communication, for example, the IEEE 802.11n, the planned IEEE 802.11 ac, and the planned IEEE 802.11ad WLAN specifications that are to provide a very high throughput in higher frequency bands. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11 ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request to Send (RTS) and the receiver may respond with a Clear to Send (CTS). The channel may be cleared by these two messages, since all STAs that hear at least one of the CTS and the CTS may suppress their own start of a transmission. The Request to Send (RTS) packet sent by the sender and the Clear to Send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear to send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

According to an example embodiment, it may also be possible to start data transmission directly without RTS-CTS signaling and in that case, the first packet carries information similar to the RTS to start protection.

According to an example embodiment, an IEEE 802.11 WLAN may also be organized as an independent basic service set (IBSS). Wireless devices in an independent basic service set (IBSS) communicate directly with one another and there is no access point in the IBSS. WLAN ad hoc networks have an independent configuration where the mobile devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format may be identical to that of an IEEE 48-bit address. In an ad hoc network, the BSSID may be a locally administered, individual address that is generated randomly by the device that starts the ad hoc network.

Synchronization is the process of the devices in an ad hoc network getting in step with each other, so that reliable communication is possible. The MAC may provide the synchronization mechanism to allow support of physical layers that make use of frequency hopping or other time-based mechanisms where the parameters of the physical layer change with time. The process may involve beaconing to announce the presence of an ad hoc network, and inquiring to find an ad hoc network. Once an ad hoc network is found, a device may join the ad hoc network. This process may be entirely distributed in ad hoc networks, and may rely on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

Since there is no AP, the mobile device that starts the ad hoc network may begin by resetting its TSF timer to zero and transmitting a beacon, choosing a beacon period. This establishes the basic beaconing process for this ad hoc network. After the ad hoc network has been established, each device in the ad hoc network will attempt to send a beacon after the target beacon transmission time (TGTT) arrives. To minimize actual collisions of the transmitted beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process may be a purely local process that occurs entirely internal to the mobile device. There may be no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

A mobile device may associate or register with an access point to gain access to the network managed by the access point. Association allows the access point to record each mobile device in its network so that frames may be properly delivered. After the mobile device authenticates to the access point, it sends an association request. The access point processes the association request and grants association by replying with an association ID (AID) that is used to identify the mobile device for delivery of buffered frames. The AID field is a value assigned by the access point during association, which represents the 16-bit ID of a mobile device. The length of the AID field is two octets, the value assigned as the AID is in the range 1-2007, and it is placed in the 14 lowest significant bits (LSBs) of the AID field, with the two most significant bits (MSBs) of the AID field each set to “1”.

An access point may maintain a polling list for use in selecting mobile devices in its network, which are eligible to receive contention free polls (CF-Polls) during contention free periods. The polling list is used to force the polling of contention free mobile devices capable of being polled, whether or not the access point has pending traffic to transmit to those mobile devices.

Whenever an access point needs to poll a group of mobile devices who already know their respective AIDs within the network that the access point manages, a contention free (CF) group poll message may be sent by the access point, having the following frame structure shown in Table 1:

TABLE 1
CF Group Poll frame structure

| Information | | | | |
|---|---|---|---|---|
| element | Frame Control | DA | TA | BSSID |
| | | Destination | MAC ID | BSSID |
| | | Address (BC/MC) | of AP | of network |
| Bits (octs) | 32 (4) | 48 (6) | 48 (6) | 48 (6) |

| Information | Number | Group | Transmit | Target power |
|---|---|---|---|---|
| element | Groups | ID | power of AP | for ACK |
| | Number of | ID of | Transmit | Target power |
| | groups | group | power class | for ACK |
| | polled | polled | of AP | messages |
| | by this | | | |
| | probe (N) | | | |
| Bits | 3 | Nx8 (N) | 4 | 4 |

| Information | Next probe for | | |
|---|---|---|---|
| element | group | Next L probes | CRC |
| | Group will be | ID of group polled | Cyclic |
| | polled again in K | in next L intervals | redundancy |
| | intervals | | check |
| Bits | Nx8 (N) | 8 + NxLx8 | 32 (4) |
| | | (1 + N*L) | |

After receiving contention free (CF) group poll message from the access point, a mobile device in the group that has data to send, transmits a response message or acknowledgement (ACK) to access point, after waiting for a short interframe space (SIFS) interval.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA is signaled through the TIM, the STA will remain awake until AP sends out all the data. The STA does not need to send a polling signal to the AP to retrieve data, which is the reason for the term “automatic” in the acronym APSD.

A Traffic Indication Map (TIM) is a field transmitted in beacon frames, used to inform associated wireless client devices that the access point has buffered data waiting to be transmitted to them. Access points buffer frames of data for wireless client devices while they are sleeping in a low-power state. The access point transmits beacons at a regular interval, the target beacon transmission time (TBTT). The Traffic Indication Map (TIM) information element in the periodically transmitted beacon frame, indicates which wireless client devices have buffered data waiting to be accessed in the access point. Each frame of buffered data is identified by an association identifier (AID) associated with a specific wireless client device. The AID is used to logically identify the wireless client device to which buffered frames of data are to be delivered. The traffic indication map (TIM) contains a bitmap, with each bit relating to a specific association identifier (AID). When data is buffered in the access point for a particular association identifier (AID), the bit is “1”. If no data is buffered, the bit for the association identifier (AID) is “0”. Wireless client devices must wake up and listen for the periodic beacon frames to receive the Traffic Indication Map (TIM). By examining the TIM, a wireless client device may determine if the access point has buffered data waiting for it. To retrieve the buffered data, the wireless client device may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to “1”, indicating that the access point has discarded the buffered data.

Two variations of the APSD feature are unscheduled automatic power save delivery (U-APSD) and scheduled automatic power save delivery (S-APSD). In U-APSD, the access point (AP) is always awake and hence a mobile wireless device (STA) in the power save mode may send a trigger frame to the AP when the STA wakes up, to retrieve any queued data at the AP. In S-APSD, the AP assigns a schedule to a STA and the STA wakes up, sends a power save poll packet to the AP in order to retrieve from the AP any data queued. An AP may maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

The IEEE 802.11 ah WLAN standard operating below 1 GHz, has a greater range and lower obstruction losses due to its longer wavelength. IEEE 802.11 ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah is sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point.

B. Resource Allocation For Sequential/Parallel Wireless Messages

In sensor networks and smart grid applications, large numbers of wireless client devices, both fixed and mobile, will need to communicate with an access point device. In the case of IEEE 802.11 ah networks, it is envisioned to have a Wi-Fi network of 6000 wireless client devices (STAs) being served by an access point (AP). The client devices may operate on battery power and must conserve their power during long periods of inactivity punctuated by short durations of communication sessions.

Typically, the access point transmits a polling message or probe signal to one group consisting of a predefined number of wireless client devices or STAs in a network managed by the access point. The basic idea of this polling message is to inquire whether wireless client devices in a group have packets to transmit to the access point. This polling message is performed over all of the groups sequentially in the network. Based on the received polling message, the wireless client devices in this group respond with a response message or an acknowledgement (ACK). The response message may provide information to the access point about the class of traffic, including a coarse estimate of the amount of data traffic allocation required by the wireless client device in the polled group.

In networks having large numbers of wireless client devices, both fixed and mobile, which need to respond to a polling message from the access point, bursts of high traffic volume may occur when many response messages are transmitted in substantially the same interval, causing significant delays due to collisions as the client devices compete for access to the wireless medium to transmit their responses.

In accordance with an example embodiment of the invention, the access point generates a polling message comprising information related to resource allocation that at least partly indicates a resource allocation in time-frequency space for a wireless client device. The wireless client device may then reply with its response message or ACK in a sequential time slot or a parallel frequency sub-band allocated by the resource allocation in the polling message. Each of the client devices in a group is allocated its own sequential time slot or parallel frequency sub-band for transmitting its respective response message, thereby enabling many client devices to gain access to the wireless medium with minimized collisions.

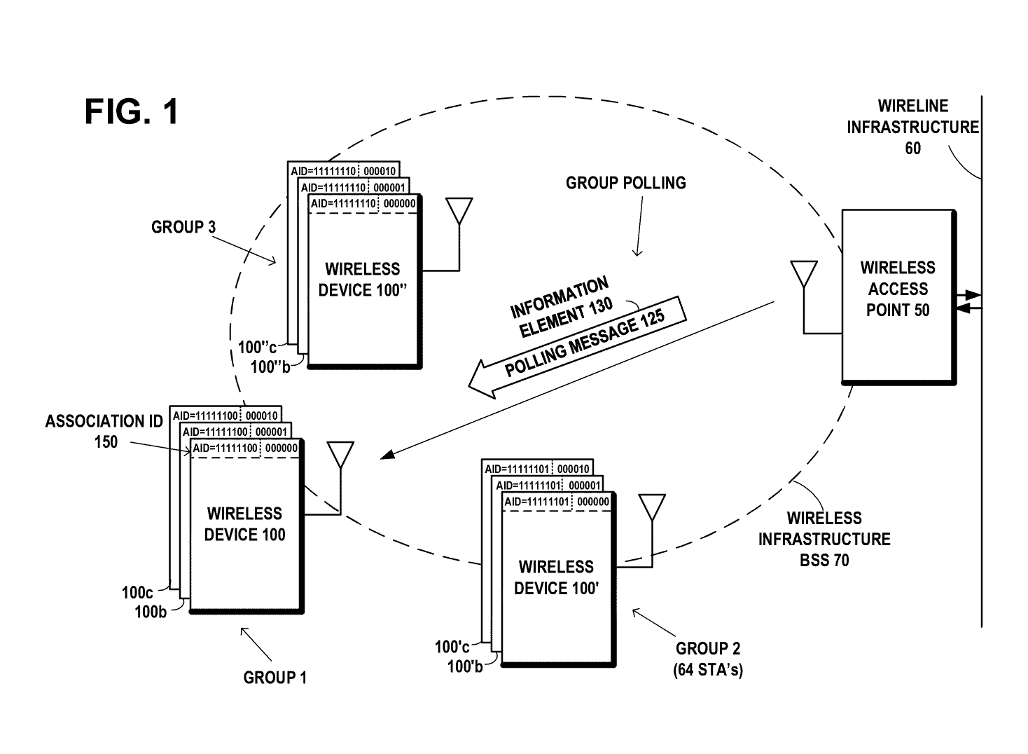

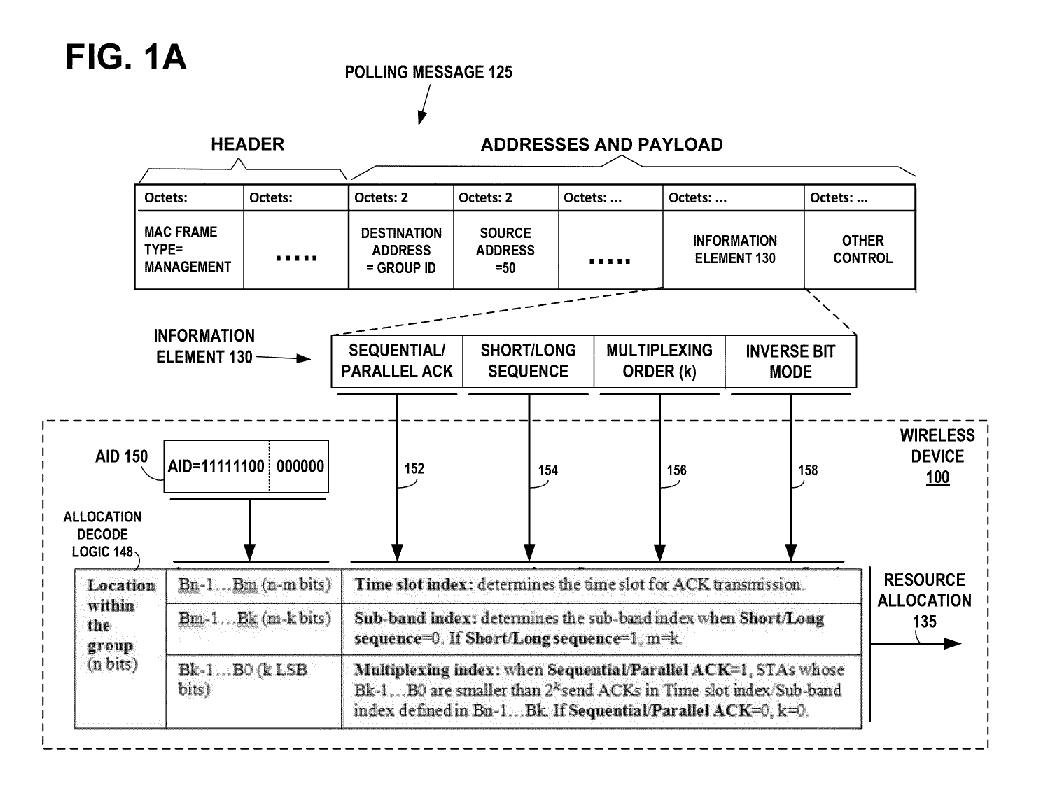

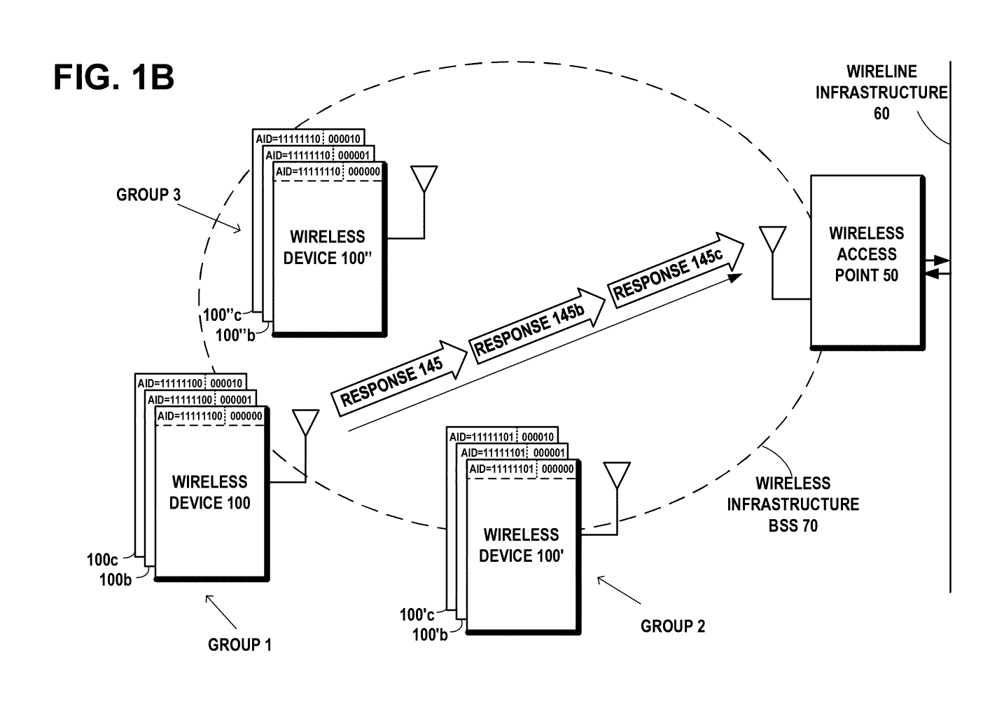

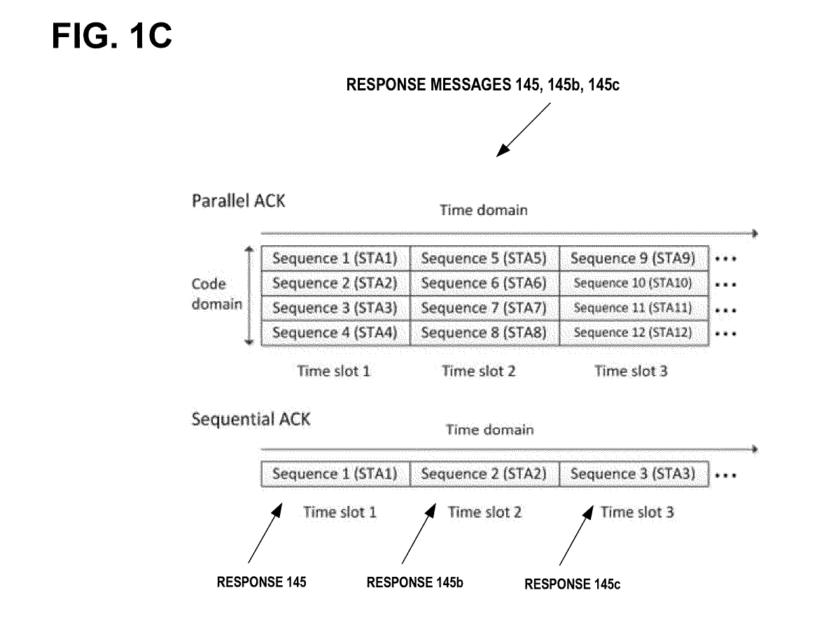

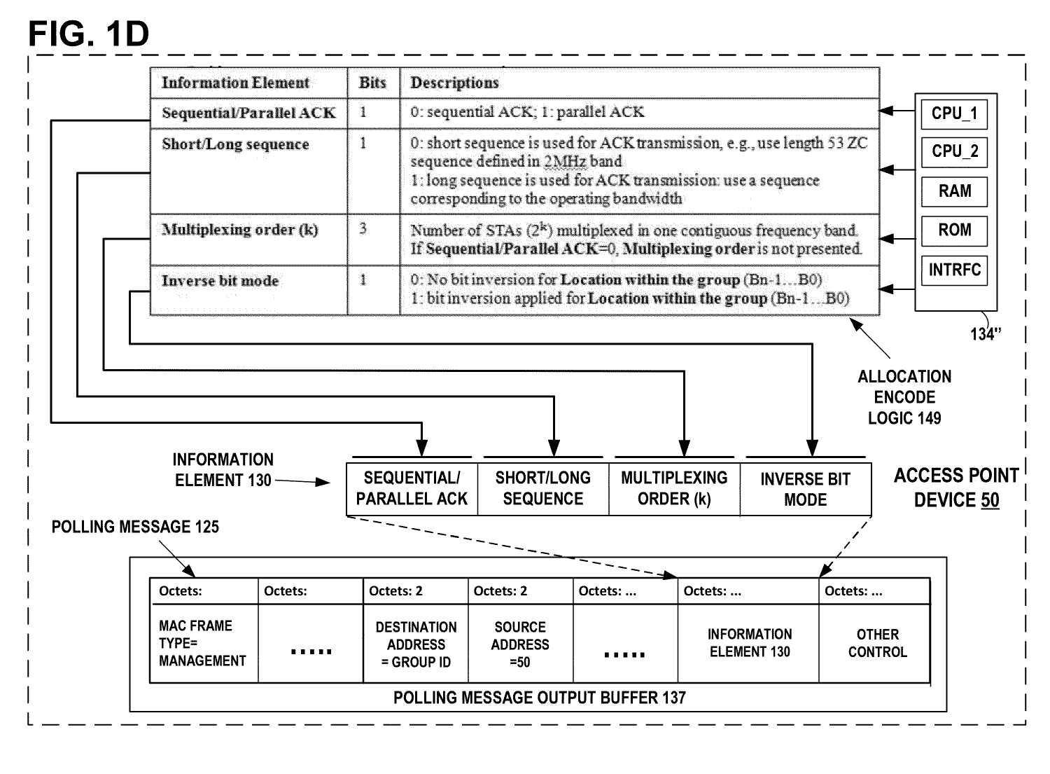

FIG. 1 shows the example network diagram, wherein a wireless access point device 50 transmits to a group, Group 1, of wireless client devices 100, 100b, and 100c, in a wireless network 70 that it manages, a polling message or contention free (CF) group poll message 125 comprising information related to resource allocation, the information element 130, that at least partly indicates a resource allocation 135 in time-frequency space for the wireless client devices 100, 100b, and 100c, in Group 1, according to an example embodiment of the invention. Each of the wireless client devices 100, 100b, and 100c, in Group 1, has a respective association ID (AID) 150. For example, the most significant eight bits (MSBs) of the AID 150, “11111100”, may identify Group 1. For example, the least significant six bits (LSBs) of the AID 150 may identify the respective wireless client devices 100, 100b, and 100c, in Group 1. For example, wireless client device 100 has the LSB of its AID 150 equal “000000”, wireless client device 100b has the LSB of its AID equal “000001”, and wireless client device 100c has the LSB of its AID equal “000010”. The six bits in the LSB of the AID 150 may represent up to 64 wireless client devices in a group. Group 2 includes wireless client devices 100′, 100′b, and 100′c and the eight most significant bits (MSBs) of the AID for Group 2 are “11111101”. Group 3 includes wireless client devices 100″, 100″b, and 100″c and the eight most significant bits (MSBs) of the AID for Group 3 are “11111110”. The eight bits in the MSB of the AID 150 may represent up to 256 groups of wireless client devices. In accordance with an example embodiment of the invention, an example structure of the AID 150, is shown in Table 1, below.

Other combinations of the 14 bits in the AID, organized into the LSB and MSB, may be used in example embodiments of the invention. In accordance with an example embodiment of the invention, the lowest significant bits of the association ID 150 expressing at least one of time slot index, sub-band index, and multiplexing index may be dynamically changed to enable time slot and frequency sub-band shuffling, to provide frequency and time diversity for transmission of the response message 145 shown in FIG. 1B.

In accordance with an example embodiment of the invention, the wireless client device 100 may be a sensor device or a node in a smart grid. Both the wireless client device 100 and the access point device 50 may be devices operating according to the IEEE 802.11ah communications protocol. The access point device 50 may be connected to a wireline infrastructure 60.

FIG. 1A shows an example frame structure of the polling message or contention free (CF) group poll message 125 that includes at least one information element 130 to signal the group of wireless client devices 100, 100b, and 100c, in Group 1, with a resource allocation for at least one of a sequence of time slots and a range of frequency sub-bands for transmitting response messages, for the wireless client devices 100, 100b, and 100c that are members of the Group 1. FIG. 1A further illustrates resource allocation decode logic 148 in the wireless client device member 100 of the Group 1, using its association identification (AID) 150 to decode the at least one information element 130 to derive a resource allocation 135 for the wireless client device 100, according to an example embodiment of the invention. In accordance with an example embodiment of the invention, the resource allocation decode logic 148 for decoding the information element 130 is described in more detail below, with reference to Table 4. The resource allocation decode logic 148 uses the AID 150 of a client wireless device or STA 100, to indicate when the client wireless device should transmit its response message or ACK, whether to use sequential or parallel transmission, and which frequency sub-band to use to transmit response message for higher bandwidth transmissions. For example, an 8 MHz bandwidth consists of four 2 MHz sub-bands.

In accordance with an example embodiment of the invention, the Sequential/Parallel ACK parameter 152 in the information element 130, informs the wireless client devices 100, 100b, and 100c in Group 1, of the option for the sequential response message or ACK and parallel response message or ACK.

In accordance with an example embodiment of the invention, the Short/Long sequence parameter 154 in the information element 130, informs the wireless client devices 100, 100b, and 100c in Group 1, of the configuration of the sequence length and transmission band (sub-band/higher-band) for sending the sequential response messages or ACKs.

In accordance with an example embodiment of the invention, the Multiplexing order parameter 156 in the information element 130, indicates the maximum number of wireless client devices 100, 100b, and 100c in Group 1, which are allowed to send response messages or ACKs in one contiguous frequency band (i.e., 2 MHz, 4 MHz, 8 MHz, and 16 MHz). The Multiplexing order is given by k.

In accordance with an example embodiment of the invention, the Inverse bit mode parameter 158 in the information element 130, informs wireless client devices 100, 100b, and 100c in Group 1, of the option for inversing bits in Location within the group. For example, when Inverse bit mode=1, the wireless client device determines the time slot and frequency sub-band from the inversed location. Additional details of the information element 130 are provided in the discussion of Tables 3 and 4, below.

FIG. 1B shows the example network diagram of FIG. 1, wherein wireless client devices 100, 100b, and 100c in Group 1, have received the polling message or contention free (CF) group poll message 125, decode it, and transmit response messages or ACKs 145, 145b, and 145c in at least one of a sequence of time slots and a range of frequency sub-bands, using the received resource allocation in time-frequency space, according to an example embodiment of the invention.

FIG. 1C shows examples of the response messages or ACKs 145, 145b, and 145c transmitted by the Group 1 of wireless client devices 100, 100b, and 100c, respectively, in at least one of a sequence of time slots and a range of frequency sub-bands, in response to the polling message, according to an example embodiment of the invention. In accordance with an example embodiment of the invention, the Parallel response messages distributed over the code domain and in sequential time slots are shown in the upper part of FIG. 1C and sequential response messages distributed over sequential time slots are shown in the lower part of FIG. 1C.

FIG. 1D shows an example functional block diagram of the access point device 50, illustrating allocation encode logic 149 in the access point device 50, to encode the at least one information element 130 for appending to the polling message 125 to transmit information related to resource allocation to a group, for example Group 1, of wireless client devices, 100, 100b, and 100c, according to an example embodiment of the invention. The processor 134″ in the access point device maintains a group polling list in its RAM or ROM memory, for use in selecting a group, such as Group 1, Group 2, or Group 3 of wireless client devices in its network 70, wherein the wireless client devices are eligible to receive contention free group polls (CF-Polls) during contention free periods. The group polling list may be used by the access point device 50 to force the polling of wireless client devices capable of being polled, whether or not the access point 50 has pending traffic to transmit to those wireless client devices.

For example, the processor 134″ may receive a user selection of a low level for compression of the response messages or ACKs. Accordingly, the processor 134″ will command the encoding logic 149 to encode the information element 130 for indicating a relatively low compression sequential time slot allocation of the response messages or ACKs that will be responding to the polling message 125 bearing the thus encoded information element 130. The thus encoded information element 130 is appended to the polling message or contention free (CF) group poll message 125, and buffered in the polling message output buffer 137 while awaiting transmission.

Alternately, the processor 134″ may determine that a particular group, for example Group 1, has a sufficiently large number of member wireless client devices 100, 100b, 100c, etc., to justify requiring a higher degree of compression of the response messages or ACKs that will be responding to a polling message 125. Accordingly, the processor 134″ will command the encoding logic 149 to encode the information element 130 for indicating a relatively high compression into parallel frequency sub-bands for the response messages or ACKs that will be responding to the polling message 125 bearing the thus encoded information element 130. The thus encoded information element 130 is appended to the polling message or contention free (CF) group poll message 125, and buffered in the polling message output buffer 137 while awaiting transmission.

A more detailed discussion of the encoding operation for the information element 130 is provided in the discussion of Table 3. below.

C. Detailed Description of the Time Slot And Sub-Band Allocation

In accordance with an example embodiment of the invention, a sequential/parallel sequence transmission by a wireless client device or station (STA) in the same or different time slots, is used to indicate to the access point (AP) whether or not STA has data to transmit. In accordance with an example embodiment of the invention, the association ID (AID) of a station (STA) is used to indicate when the STA should transmit its acknowledgement (ACK), whether to use sequential or parallel transmission, and which sub-band to use to transmit for higher bandwidth transmissions. For example an 8 Mhz bandwidth consists of four 2 Mhz sub-bands.

In accordance with an example embodiment of the invention, ACK allocation information is delivered by defining a map from a time slot index, a sub-band index, and a multiplexing index to bit positions in the ‘n’ lowest significant nits (LSBs) of the association ID (AID), where the ‘n’ may be dynamically changed. association ID (AID) new signaling enables time slot and frequency sub-band shuffling, based on a one-bit indication in the polling message or CF Group Poll. This is done by inversing the ‘n’ LSBs of the AID, which provides a simple form of frequency and time diversity for ACK transmission.

By decoding the Association ID (AID), the STA learns about the Group ID and Location within the group as shown in Table 2.

TABLE 2
Group Association ID structure

| | | |
|---|---|---|
| Association | B13 . . . Bn (13 − n + 1 | Group ID |
| ID (13 bits) | bits) | |
| | Bn − 1 . . . B0 (n LSB | Location within the group |
| | bits) | |

There are total 2¹³⁻ⁿ⁺¹ groups with the group size of 2ⁿ. By Group ID in Table 2, STA will know from CF Group Poll whether its group is probed or not. In Table 2, the bit position ‘n’, that divides AID into Group ID and Location within the group, can be changed dynamically. For instance of n=6, there are total 2⁸=256 groups where each group consists of 2⁶=64 STAs. Location within the group comprises ACK allocation information for a group.

In accordance with an example embodiment of the invention, new information elements are appended in CF Group Poll as shown in Table 3. The new information elements signal to STAs options for sequential/parallel transmission, sub-band/higher-band transmission, and multiplexing order for sending ACKs. These information elements provide means for a STA to interpret Location within the group field in AID for allocating time slot and frequency sub-band for transmitting sequential/parallel ACK sequences

TABLE 3
Appended information elements to CF Group Poll

| Information | | |
|---|---|---|
| Element | Bits | Descriptions |
| Sequential/ | 1 | 0: sequential ACK; 1: parallel ACK |
| Parallel ACK | | |
| Short/Long | 1 | 0: short sequence is used for ACK transmission, |
| sequence | | e.g., use length 53 ZC sequence defined in 2 |
| | | MHz band |
| | | 1: long sequence is used for ACK transmission: |
| | | use a sequence corresponding to the operating |
| | | bandwidth |
| Multiplexing | 3 | Number of STAs (2^{k}) multiplexed in one |
| order (k) | | contiguous frequency band. If Sequential/Parallel |
| | | ACK = 0, Multiplexing order is not presented. |
| Inverse | 1 | 0: No bit inversion for Location within the group |
| bit mode | | (Bn − 1 . . . B0) |
| | | 1: bit inversion applied for Location within the |
| | | group (Bn − 1 . . . B0) |

Sequential/Parallel ACK in Table 3 informs STAs (in the probed group) the option for the sequential ACK and parallel ACK.

Short/Long sequence in Table 3 informs STAs the configuration of the sequence length and transmission band (sub-band/higher-band) for sending ACKs.

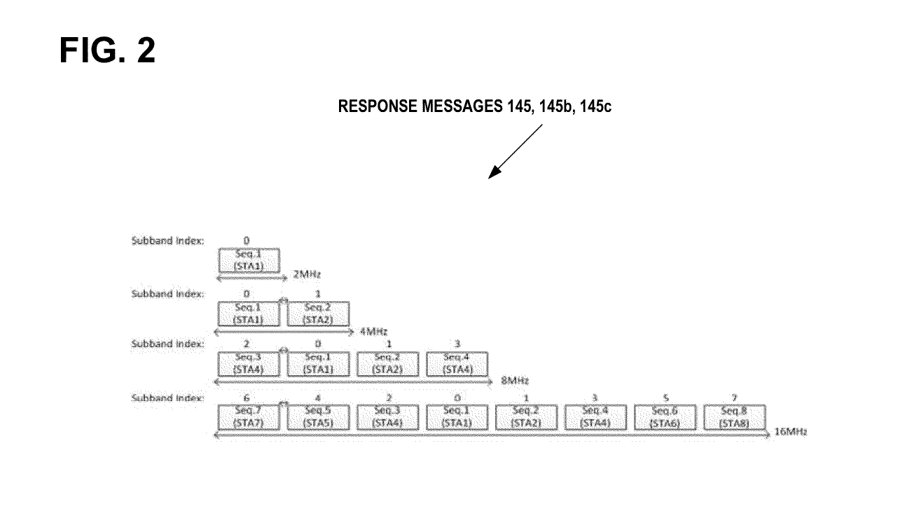

Short/Long sequence=0 indicates STA (in the probed group) to send ACK with sub-band transmission by using short sequence. This mode divides broad band (e.g., 4 MHz, 8 MHz, and 16 MHz) into equally spaced sub-bands (e.g., 2 MHz) and allows multiple STAs to transmit ACKs in sub-bands. For instance, when AP/STAs are operating in 16 MHz band, multiple 2 MHz sub-bands are orthogonally allocated to STAs and STAs transmit ACKs by using the length 53 ZC sequence. FIG. 2 shows a scenario when Sequential/Parallel ACK=0 and Short/Long sequence=0. Broad bands 4 MHz, 8 MHz, and 16 MHz are divided into multiple orthogonal 2 MHz sub-bands. STA sending ACK in sub-band can use either 64 point FFT or FFT size that corresponds to the operating band (i.e., 128 FFT for 40 MHz, 256 FFT for 80 MHz, and 521 FFT for 16 MHz) with zero-padding subcarriers not in the allocated sub-band.

FIG. 2 illustrates an example distribution of response messages or ACKs over allocated frequency sub-bands when the value of the parameters Sequential/Parallel ACK=0 and Short/Long sequence=0, in accordance with an example embodiment of the invention.

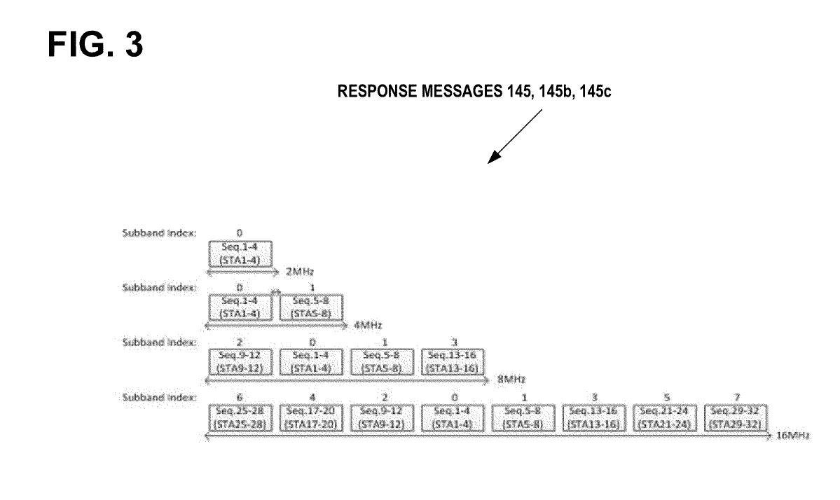

When the value of the parameters Sequential/Parallel ACK=1 and Short/Long sequence=0, multiple STAs concurrently send ACKs in one sub-band. For instance, FIG. 3 illustrates the case when 4 STAs are allocated in one 2 MHz sub-band (parallel ACK) for 4 MHz, 8 MHz, and 16 MHz bands.

FIG. 3 illustrates an example distribution of response messages or ACKs over allocated frequency sub-bands when the value of the parameters Sequential/Parallel ACK=1 and Short/Long sequence=0, in accordance with an example embodiment of the invention.

Short/Long sequence=1 informs STAs to use sequences with the length corresponding to the operating bandwidth (i.e., no sub-band transmission using short sequence).

Multiplexing order in Table 3 indicates the maximum number of STAs that are allowed to send ACKs in one contiguous frequency band (i.e., 2 MHz, 4 MHz, 8 MHz, and 16 MHz). For instance of FIG. 3, the Multiplexing order is given by 4. When Sequential/Parallel ACK=1 and Short/Long sequence=1, Multiplexing order corresponds to the number of STAs transmitting ACKs in the operating bandwidth (e.g., 2 MHz, 4 MHz, 8 MHz, 16 MHz). The information element Multiplexing order will not be presented if Sequential/Parallel ACK=0.

In accordance with an example embodiment of the invention, Time slot index, Sub-band index, and Multiplexing index information are maintained in Location within the group in Table 2. Mapping from Time slot index, Sub-band index, and Multiplexing index information to bits in Location within the group is illustrated in Table 4.

TABLE 4
Bitmap for Time slot index, Sub-band index, and
Multiplexing order in Location within the group

| | | |
|---|---|---|
| Location | Bn − 1 . . . Bm | Time slot index: determines the time slot |
| within | (n-m bits) | for ACK transmission. |
| the | Bm − 1 . . . Bk | Sub-band index: determines the sub-band |
| group | (m-k bits) | index when Short/Long sequence = 0. |
| (n bits) | | If Short/Long sequence = 1, m = k. |
| | Bk − 1 . . . B0 | Multiplexing index: when Sequential/Parallel |
| | (k LSB bits) | ACK = 1, STAs whose Bk − 1 . . . B0 are |
| | | smaller than 2^{k}send ACKs in Time slot |
| | | index/Sub-band index defined in Bn − 1 . . . |
| | | Bk. If Sequential/Parallel ACK = 0, k = 0. |

If Sequential/Parallel ACK=0 and Short/Long sequence=1, then m=k=0 in Table 4. In this case, Location within the group directly determines the time slot for the STA to send ACK. For instance of n=6, if Location within the group has B5 . . . B0=000010, this STA transmits ACK at the third time slot. If B5 . . . B0=000000, this STA transmits ACK at the first time slot.
If Sequential/Parallel ACK=1 and Short/Long sequence=1, then m=k. In this case, first k LSBs of Location within the group indicate the multiplexing index and n-k MSBs determine the time slot. For instance of n=6 and k=2, STAs with B5 . . . B0=000000, 000001, 000010, 000011 will send ACKs at the first time slot concurrently and STAs with B5 . . . B0=000100, 000101, 000110, 000111 will send ACKs at the second time slot concurrently.
If Sequential/Parallel ACK=0 and Short/Long sequence=0, then k=0 in Table 4. First m LSBs of Location within the group indicate the sub-band index (e.g., FIG. 2) and n-m MSBs determine the time slot.
If Sequential/Parallel ACK=1 and Short/Long sequence=0, then n>m>k>0. First k LSBs of Location within the group indicate the multiplexing index, next m-k bits signals the sub-band index, and n-m MSBs determine the time slot. For instance of n=5, m=4, and k=2, STAs with B4 . . . B0=00000, 00001, 00010, 00011 are allocated in the first sub-band in the first time slot, and STAs with B4 . . . B0=11000, 11001, 11010, 11011 will send ACKs at the third sub-band in the second time slot.

Inverse bit mode in Table 3 informs STAs (in the probed group) the option for inversing bits in Location within the group. When Inverse bit mode=1, STA determines the time slot and frequency sub-band from the inversed location. For instance of n=5, given B5 . . . B0=000010 the inversed Location within the group is given by B5 . . . B0=111101. Inverse bit mode will enable to obtain a simple form of frequency diversity.

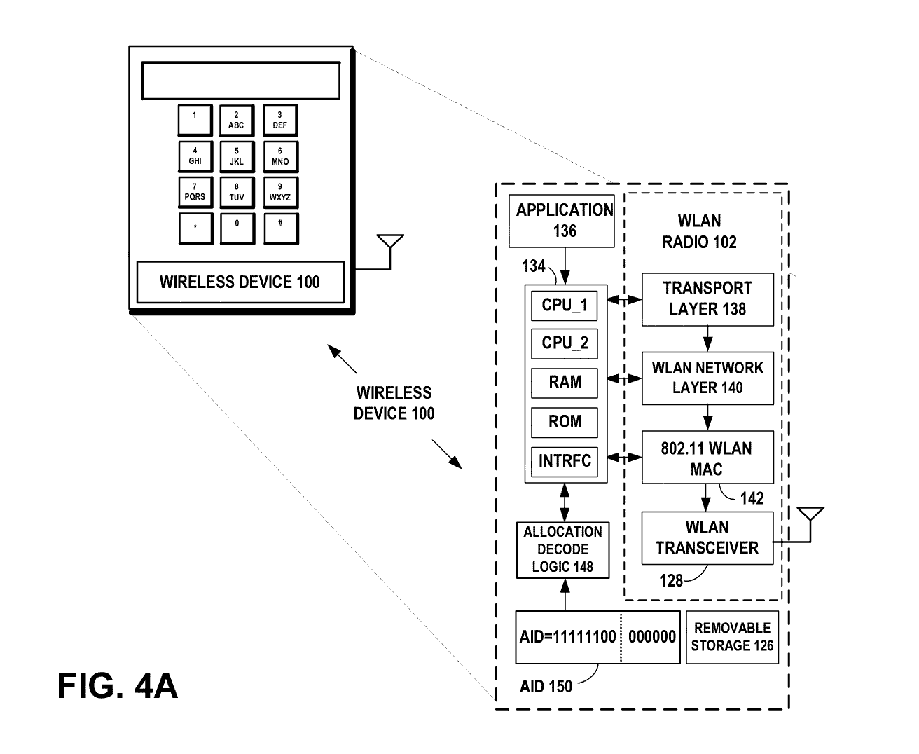

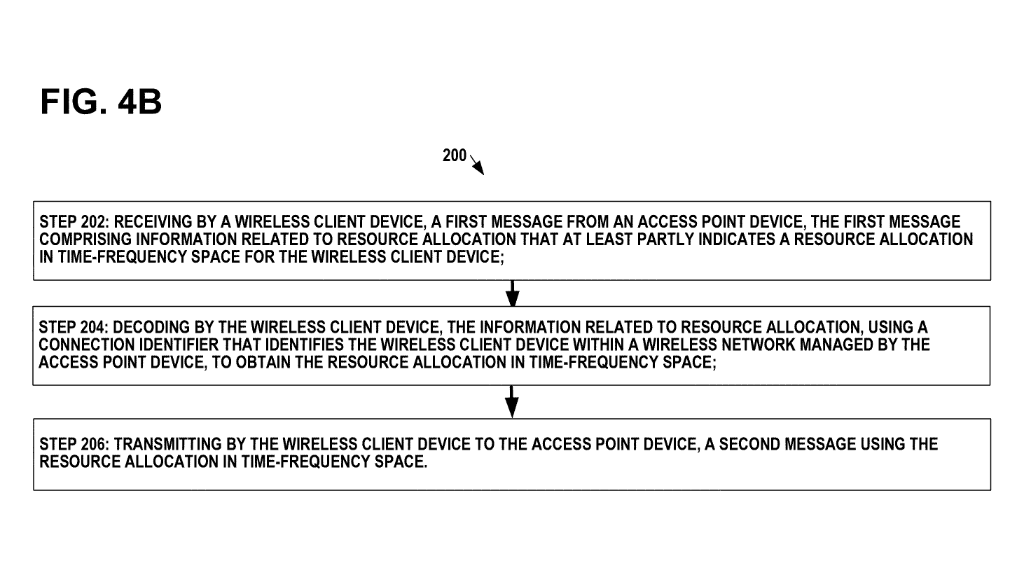

FIG. 4A is an example functional block diagram, illustrating an example wireless client device 100, according to an example embodiment of the invention. The example wireless client device 100 may include a processor 134 that may include a dual or multi-core central processing unit CPU_1 and CPU_2, a RAM memory, a ROM memory, and an interface for a keypad, display, and other input/output devices. The example wireless client device 100 may include a protocol stack, including the transceiver 128 and IEEE 802.11 MAC 142, which may be based, for example, on the IEEE 802.11 ah WLAN standard. The protocol stack may also include a network layer 140, a transport layer 138, and an application program 136.

FIG. 4A further illustrates resource allocation decode logic 148 in the wireless client device member 100 of the Group 1, using its association identification (AID) 150 to decode the at least one information element 130 to derive a resource allocation 135 for the wireless client device 100, according to an example embodiment of the invention. In accordance with an example embodiment of the invention, the resource allocation decode logic 148 uses the AID 150 of a client wireless device or STA 100, to indicate when the client wireless device should transmit its response message or ACK, whether to use sequential or parallel transmission, and which frequency sub-band to use to transmit response message for higher bandwidth transmissions.

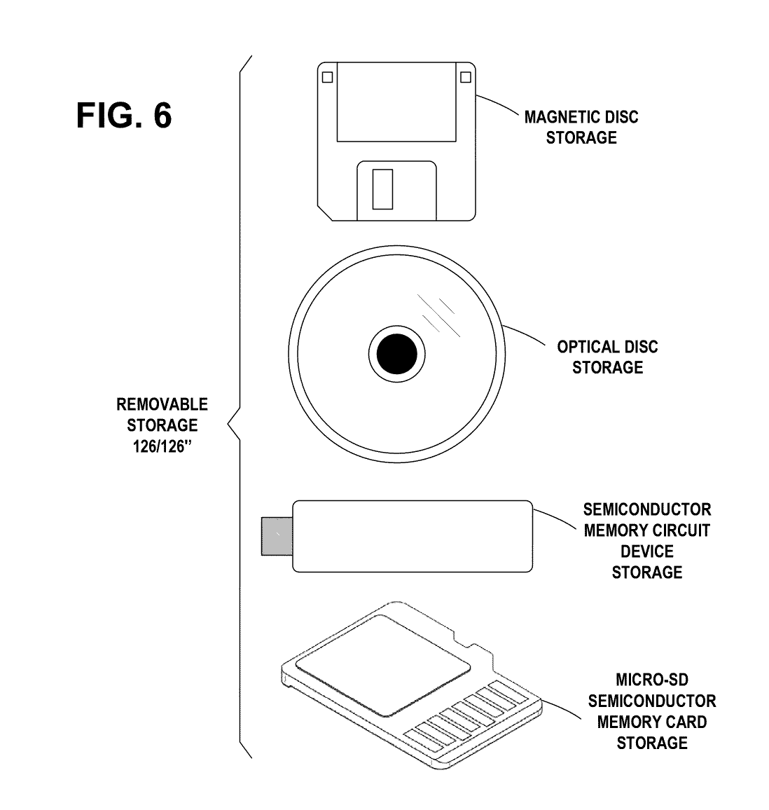

In an example embodiment, the interface circuits in FIG. 4A may interface with one or more radio transceivers, battery and other power sources, key pad, touch screen, display, microphone, speakers, ear pieces, camera or other imaging devices, etc. The RAM and ROM may be removable memory devices 126 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 6, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, the wireless client device 100 of FIG. 4A, comprises:

at least one processor 134;

at least one memory, RAM, ROM, and/or removable storage 126 including computer program code represented by the flow diagram of FIG. 4B;

the at least one memory and the computer program code configured to, with the at least one processor, cause the wireless client device 100 at least to:

receive by a wireless client device 100, a polling message 125 from an access point device 50, the polling message comprising a information related to resource allocation 130 that at least partly indicates a resource allocation 135 in time-frequency space for the wireless client device 100;

decode by the wireless client device 100, the information related to resource allocation 130, using a connection identifier AID 150 that identifies the wireless client device 100 within a wireless network 70 managed by the access point device 50, to obtain the resource allocation 135 in time-frequency space; and

transmit by the wireless client device 100 to the access point device 50, a response message 145 using the received resource allocation 135 in time-frequency space.

FIG. 4B is an example flow diagram 200 of operational steps in the wireless client device 100 of FIG. 4A, wherein the wireless client device 100 receives from the wireless access point device 50, a polling message 125 comprising a information related to resource allocation 130 that at least partly indicates a resource allocation 135 in time-frequency space for the wireless client device 100, wherein the connection identifier 130 identifies the wireless client device 100 within a wireless network 70 managed by the access point device 50, according to an example embodiment of the invention.

The steps of the flow diagram 200 of FIG. 4B may represent computer code instructions stored in the RAM and/or ROM memory of the wireless client device 100, which when executed by the central processing units (CPU), carry out the functions of an example embodiment of the invention. The steps may be carried out in another order than shown and individual steps may be combined or separated into component steps.

Step 202: receiving by a wireless client device, a first message from an access point device, the first message comprising information related to resource allocation that at least partly indicates a resource allocation in time-frequency space for the wireless client device;

Step 204: decoding by the wireless client device, the information related to resource allocation, using a connection identifier that identifies the wireless client device within a wireless network managed by the access point device, to obtain the resource allocation in time-frequency space; and

Step 206: transmitting by the wireless client device to the access point device, a second message using the resource allocation in time-frequency space.

The polling message from the access point device may be addressed to a group of wireless client devices in the wireless network and the polling message may include at least on information element to signal to the wireless client device an allocation of a time slot for the response message to be transmitted in a sequence of time slots bearing response messages transmitted from the group of wireless client devices to the access point device.

The polling message from the access point device may be addressed to a group of wireless client devices in the wireless network and the polling message may include one or more information elements to signal to the wireless client device an allocation of a transmission sub-band for the response message to be transmitted in a transmission band comprised of a group of sub-bands bearing response messages transmitted from the group of wireless client devices to the access point device.

The polling message from the access point device uses an association ID of the wireless client device to indicate a response message allocation comprising at least one of when the wireless client device should transmit a response message and which sub-band to use to transmit a response message for higher bandwidth transmissions. The response message allocation is specified by at least one of a time slot index, a sub-band index, and a multiplexing index expressed by bit positions in lowest significant bits of the association ID of the wireless client device. The lowest significant bits of the association ID expressing the at least one of time slot index, sub-band index, and multiplexing index can be dynamically changed to enable time slot and frequency sub-band shuffling, to provide frequency and time diversity for response message transmission.

The wireless client device may receive another message from the access point device, the another message comprising information that can be used in addition to the information related to resource allocation, to determine at least one of a time slot and a frequency sub-band for transmitting the second message to the access point device.

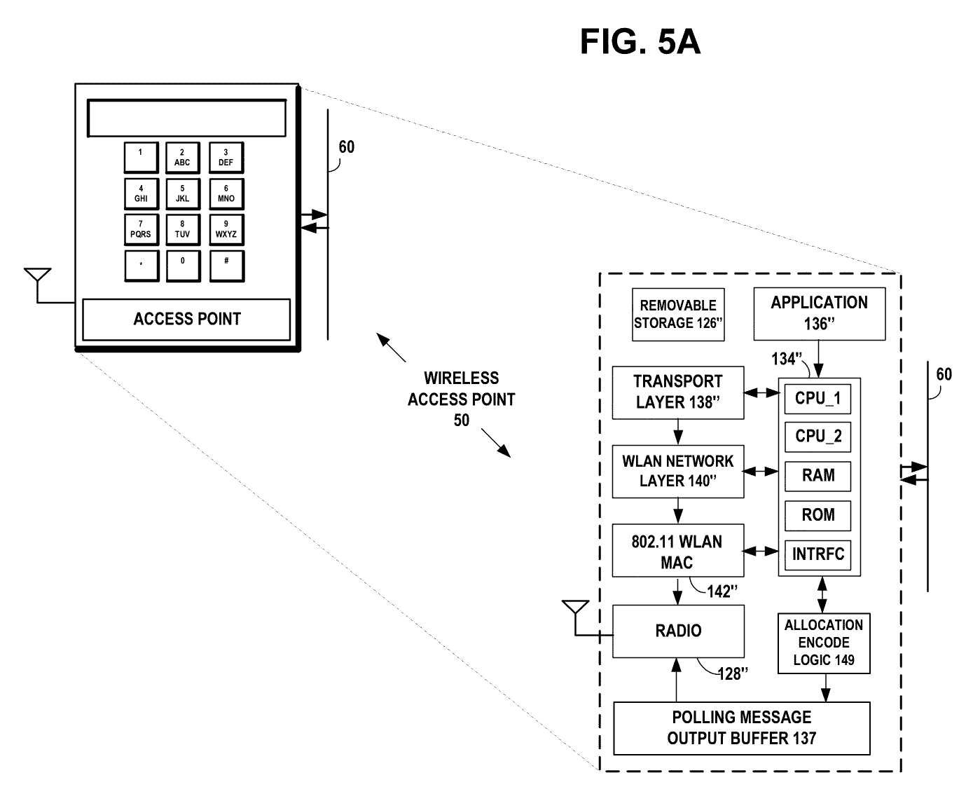

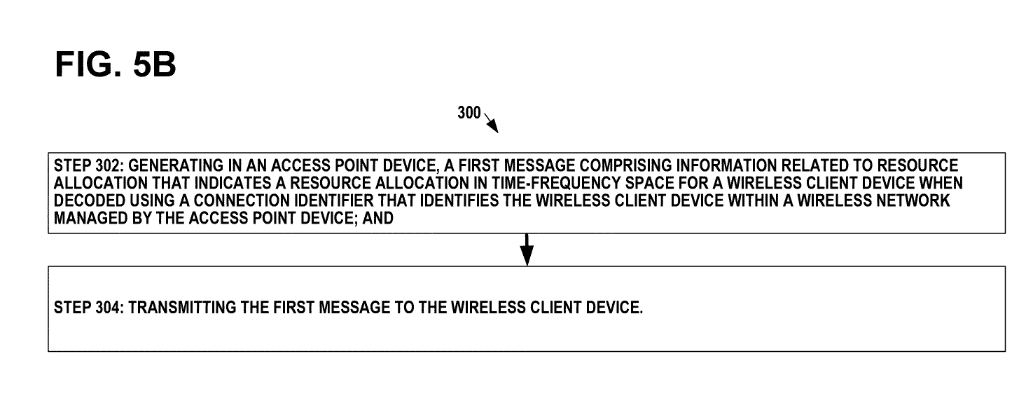

FIG. 5A is an example functional block diagram, illustrating an example wireless access point device 50, according to an example embodiment of the invention. The example wireless access point device 50 may include a processor 134″ that may include a dual or multi-core central processing unit CPU_1 and CPU_2, a RAM memory, a ROM memory, and an interface for a keypad, display, and other input/output devices. The example wireless access point device 50 may include a protocol stack, including the transceiver 128″ and IEEE 802.11ah MAC 142″, which may be based, for example, on the IEEE 802.11ah WLAN standard. The protocol stack may also include a network layer 140″, a transport layer 138″, and an application program 136″.

FIG. 5A shows the allocation encode logic 149 in the access point device 50, to encode the at least one information element 130 for appending to the polling message 125 to transmit information related to resource allocation to a group, for example Group 1, of wireless client devices, 100, 100b, and 100c, according to an example embodiment of the invention. The thus encoded information element 130 is appended to the polling message or contention free (CF) group poll message 125, and buffered in the polling message output buffer 137 while awaiting transmission.

In an example embodiment, the interface circuits in FIG. 5A may interface with one or more radio transceivers, battery and other power sources, key pad, touch screen, display, microphone, speakers, ear pieces, camera or other imaging devices, etc. The RAM and ROM may be removable memory devices 126″ such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126″, as shown in FIG. 6, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, the wireless access point device 50 of FIG. 5A, comprises:

at least one processor 134″;

at least one memory, RAM, ROM, and/or removable storage 126″ including computer program code represented by the flow diagram of FIG. 5B;

the at least one memory and the computer program code configured to, with the at least one processor, cause the wireless access point device 50 at least to:

generate a polling message 125 comprising a information related to resource allocation 130 that indicates a resource allocation 135 in time-frequency space for a wireless client device 100, when decoded using a connection identifier AID 150 that identifies the wireless client device within a wireless network 70 managed by the access point device 50; and

transmitting the polling message 125 to the wireless client device 100.

FIG. 5B is an example flow diagram 300 of operational steps in the wireless access point device 50 of FIG. 5A, wherein the wireless access point device generates a polling message 125 comprising a information related to resource allocation 130 that at least partly indicates a resource allocation 135 in time-frequency space for a wireless client device 100, wherein the connection identifier 130 identifies the wireless client device 100 within a wireless network 70 managed by the access point device 50, according to an example embodiment of the invention.

The steps of the flow diagram 300 of FIG. 5B may represent computer code instructions stored in the RAM and/or ROM memory, which when executed by the central processing units (CPU), carry out the functions of an example embodiment of the invention. The steps may be carried out in another order than shown and individual steps may be combined or separated into component steps.

Step 302: generating in an access point device, a first message comprising information related to resource allocation that indicates a resource allocation in time-frequency space for a wireless client device when decoded using a connection identifier that identifies the wireless client device within a wireless network managed by the access point device; and

Step 304: transmitting the first message to the wireless client device.

The polling message transmitted by the access point device may be addressed to a group of wireless client devices in the wireless network and the polling message may include at least on information element to signal to the wireless client device an allocation of a time slot for the response message to be transmitted in a sequence of time slots bearing response messages transmitted from the group of wireless client devices to the access point device.

The polling message transmitted by the access point device may be addressed to a group of wireless client devices in the wireless network and the polling message may include one or more information elements to signal to the wireless client device an allocation of a transmission sub-band for the response message to be transmitted in a transmission band comprised of a group of sub-bands bearing response messages transmitted from the group of wireless client devices to the access point device.

The polling message transmitted by the access point device uses an association ID of the wireless client device to indicate a response message allocation comprising at least one of when the wireless client device should transmit a response message and which sub-band to use to transmit a response message for higher bandwidth transmissions. The response message allocation is specified by at least one of a time slot index, a sub-band index, and a multiplexing index expressed by bit positions in lowest significant bits of the association ID of the wireless client device. The lowest significant bits of the association ID expressing the at least one of time slot index, sub-band index, and multiplexing index can be dynamically changed to enable time slot and frequency sub-band shuffling, to provide frequency and time diversity for response message transmission.

The access point device may transmit to the wireless client device another message, the another message comprising information that can be used in addition to the information related to resource allocation, to determine at least one of a time slot and a frequency sub-band for transmitting the second message to the access point device.

FIG. 6 illustrates an example embodiment of the invention, wherein examples of removable storage media 126 and 126″ are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, wireless networks may include other sensor type networks and/or other networks having a large number of supported stations/apparatuses. Examples of such networks include, for example cellular systems such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks, as well as short range networks such as Bluetooth, Zigbee, IEEE 802.11, Digital Enhanced Cordless Telecommunications (DECT), HiperLAN, Radio Frequency Identification (RFID), Wireless USB, DSRC (Dedicated Short Range Communications), Near Field Communication, wireless sensor networks, EnOcean; TransferJet, Ultra-wideband (UWB from WiMedia Alliance), WLAN, WiFi, and HiperLAN.

In accordance with an example embodiment of the invention, the wireless client device 100 may be, for example, a miniature device such as a key fob, smart card, jewelry, or the like. The wireless client device 100 may be, for example, a larger device such as a cell phone, smart phone, flip-phone, PDA, graphic pad, or even larger devices such as a laptop computer, an automobile, and the like.

In an example embodiment of the invention, an apparatus comprises:

means for receiving by a wireless client device, a first message from an access point device, the first message comprising information related to resource allocation that at least partly indicates a resource allocation in time-frequency space for the wireless client device, wherein the connection identifier identifies the wireless client device within a wireless network managed by the access point device;

means for decoding by the wireless client device, the first message; and

means for transmitting by the wireless client device to the access point device, a second message using the received resource allocation in time-frequency space.

In an example embodiment of the invention, an apparatus comprises:

means for generating in an access point device, a first message comprising information related to resource allocation that at least partly indicates a resource allocation in time-frequency space for a wireless client device, wherein the connection identifier identifies the wireless client device within a wireless network managed by the access point device; and

means for transmitting the first message to the wireless client device.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
receiving by a wireless client device, a first message from an access point device, the first message comprising information related to resource allocation that at least partly indicates a resource allocation in time-frequency space for the wireless client device;
decoding by the wireless client device, the information related to resource allocation, using a connection identifier that identifies the wireless client device within a wireless network managed by the access point device, to obtain the resource allocation in time-frequency space; and
transmitting by the wireless client device to the access point device, a second message using the resource allocation in time-frequency space.

2. The method of claim 1, further comprising:
receiving by the wireless client device, another message from the access point device, the another message comprising information that can be used in addition to the information related to resource allocation, to determine at least one of a time slot and a frequency sub-band for transmitting the second message to the access point device.

3. The method of claim 1, wherein the first message includes information related to an allocation of at least one of a time slot for transmission of the second message and a sub-band for transmission of the second message.

4. The method of claim 1, wherein the wireless client device decodes the information related to resource allocation using an association identification of the wireless client device to derive an allocation of resources for the second message, comprising at least one of when the wireless client device should transmit the second message and which sub-band to use to transmit the second message.

5. The method of claim 4, wherein the second message allocation is specified by at least one of a time slot index, a sub-band index, and a multiplexing index expressed by bit positions in lowest significant bits of the association identification of the wireless client device and the lowest significant bits can be dynamically changed to enable time slot and frequency sub-band shuffling, to provide frequency and time diversity for response message transmission.

6. A method, comprising:
generating in an access point device, a first message comprising information related to resource allocation that indicates a resource allocation in time-frequency space for a wireless client device when decoded using a connection identifier that identifies the wireless client device within a wireless network managed by the access point device; and
transmitting the first message to the wireless client device.

7. The method of claim 6, further comprising:
transmitting by the access point device to the wireless client device, another message comprising information that can be used in addition to the information related to resource allocation, to determine at least one of a time slot and a frequency sub-band for the wireless client device to transmit a second message.

8. The method of claim 6, wherein the first message includes information related to at least one of a time slot for transmission of a second message and a sub-band for transmission for the wireless client device to transmit the second message.

9. The method of claim 6, wherein an allocation of resources for the wireless client device, is based on the information related to resource allocation and an association identification of the wireless client device, the allocation of resources for the wireless client device, comprising at least one of when the wireless client device should transmit a second message and which sub-band to use to transmit the second message.

10. The method of claim 9, wherein the second message allocation is specified by at least one of a time slot index, a sub-band index, and a multiplexing index expressed by bit positions in lowest significant bits of the association identification of the wireless client device and the lowest significant bits can be dynamically changed to enable time slot and frequency sub-band shuffling, to provide frequency and time diversity for response message transmission.

11. An apparatus, comprising:
at least one processor;
at least one memory including computer program code;
the at least one memory and the computer program code configured to, with the at least one processor, cause the apparatus at least to:
receive a first message from an access point device, the first message comprising information related to resource allocation that at least partly indicates a resource allocation in time-frequency space for the apparatus;
decode the information related to resource allocation, using a connection identifier that identifies the apparatus within a wireless network managed by the access point device, to obtain the resource allocation in time-frequency space; and
transmit to the access point device, a second message using the resource allocation in time-frequency space.

12. The apparatus of claim 11, further comprising:
the at least one memory and the computer program code configured to, with the at least one processor, cause the apparatus at least to:
receive another message from the access point device, the another message comprising information that can be used in addition to the information related to resource allocation, to determine at least one of a time slot and a frequency sub-band for transmitting the second message to the access point device.

13. The apparatus of claim 11, wherein the first message includes information related to an allocation of at least one of a time slot for transmission of the second message and a sub-band for transmission of the second message.

14. The apparatus of claim 11, wherein the apparatus decodes the information related to resource allocation using an association identification of the apparatus to derive an allocation of resources for the second message, comprising at least one of when the apparatus should transmit the second message and which sub-band to use to transmit the second message.

15. An apparatus, comprising:
at least one processor;
at least one memory including computer program code;
the at least one memory and the computer program code configured to, with the at least one processor, cause the apparatus at least to:
generate a first message comprising information related to resource allocation that indicates a resource allocation in time-frequency space for a wireless client device when decoded using a connection identifier that identifies the wireless client device within a wireless network managed by the apparatus; and
transmit the first message to the wireless client device.

16. The apparatus of claim 15, further comprising:
the at least one memory and the computer program code configured to, with the at least one processor, cause the apparatus at least to:
transmit to the wireless client device, another message comprising information that can be used in addition to the information related to resource allocation, to determine at least one of a time slot and a frequency sub-band for the wireless client device to transmit a second message.

17. The apparatus of claim 15, wherein the first message includes information related to an allocation of at least one of a time slot for transmission of a second message and a sub-band for transmission for the wireless client device to transmit the second message.

18. The apparatus of claim 15, wherein an allocation of resources for the wireless client device, is based on the information related to resource allocation and an association identification of the wireless client device, the allocation of resources for the wireless client device, comprising at least one of when the wireless client device should transmit a second message and which sub-band to use to transmit the second message.

19. A computer program product comprising computer executable program code recorded on a computer readable, non-transitory storage medium, the computer executable program code comprising:
code for receiving by a wireless client device, a first message from an access point device, the first message comprising information related to resource allocation that at least partly indicates a resource allocation in time-frequency space for the wireless client device;
code for decoding by the wireless client device, the information related to resource allocation, using a connection identifier that identifies the wireless client device within a wireless network managed by the access point device, to obtain the resource allocation in time-frequency space; and
code for transmitting by the wireless client device to the access point device, a second message using the resource allocation in time-frequency space.

20. A computer program product comprising computer executable program code recorded on a computer readable, non-transitory storage medium, the computer executable program code comprising:
code for generating in an access point device, a first message comprising information related to resource allocation that indicates a resource allocation in time-frequency space for a wireless client device when decoded using a connection identifier that identifies the wireless client device within a wireless network managed by the access point device; and
code for transmitting the first message to the wireless client device.
